(19) United States
(12) Patent Application Publication
(10) Pub. No.: US 2026/0279610 A1
(43) Pub. Date: Sep. 17, 2026

(54) CROSS-SCALE NEUTRONIC-THERMAL-MATERIAL COUPLING SIMULATION METHOD FOR PRESSURIZED WATER REACTOR CORROSION-RELATED UNIDENTIFIED DEPOSITS (CRUD)

(71) Applicant: SHANGHAI JIAO TONG UNIVERSITY, Shanghai (CN)

(72) Inventors: Xiaojing Liu, Shanghai (CN); Tengfei Zhang, Shanghai (CN); Chaoyuan Zhang, Shanghai (CN); Hui He, Shanghai (CN); Yan Liu, Shanghai (CN)

(73) Assignee: SHANGHAI JIAO TONG UNIVERSITY, Shanghai (CN)

(21) Appl. No.: 19/458,721

(22) Filed: Jan. 24, 2026

(30) Foreign Application Priority Data
Mar. 13, 2025 (CN) 202510298240 .2

(51) Int. Cl. G21D 3/00

(52) U.S. Cl. CPC G21D 3/005

(57) ABSTRACT

A pressurized water reactor oxidation corrosion product cross-scale neutronic-thermal-material coupling simulation method comprises the following steps: in the first stage, obtaining a supercooled boiling position through mutual loop iteration simulation of a neutronics model and a thermal hydraulic model; and in the second stage, multiphysics field coupling simulation is carried out through an oxidation corrosion product (CRUD) model, a neutronics model and a thermal hydraulic model, and high-resolution simulation under the pressurized water reactor neutronic-thermal-material coupling condition is obtained. According to the method, a scene in which the thickness range of the oxidation corrosion product is 20-200 microns is considered, multiphysical fields such as pressurized water reactor neutron physics, flow heat transfer and oxidation corrosion product deposition are calculated and analyzed, and the complex physical process can be captured more accurately.

### CROSS-REFERENCE TO RELATED APPLICATIONS

This application claims priority to Chinese Patent Application Ser. No. CN202510298240.2 filed on 13 Mar. 2025.

### TECHNICAL FIELD

The present invention relates to a technology in the field of reactor materials, specifically a cross-scale neutronic-thermal-material coupling simulation method for CRUD of pressurized water reactors.

### BACKGROUND ART

During long-term operation of pressurized water reactors (PWRs), subcooled nucleate boiling (SNB) occurs in some reactor fuel rods, resulting in the deposition of CRUD on their outer surfaces. The porous structure of the fuel rods exacerbates this internal boiling, leading to boron enrichment in the CRUD layer. Due to boron's high neutron absorption cross-section, this can lead to localized neutron flux and power depression, which can cause axial power shifts in the reactor, posing a threat to reactor safety. Existing reactor core multiphysics coupling technologies, when performing high-resolution modeling of corrosion products, ignore cross-scale modeling physics calculations and the subcooled nucleate boiling of the physical field, failing to reflect the actual physical conditions.

### SUMMARY OF THE INVENTION

In response to the shortcomings of the existing technology, which is limited to fixed heat flux boundary condition or CRUD interaction of a single fuel rod, and fails to carefully analyze the power distribution variations inside the fuel assembly and its impact on CRUD and axial power offset, and fails to consider the impact of corrosion products on thermal conductivity changes and the overall physical field, the present invention proposes a cross-scale neutronic-thermal-material coupling simulation method for pressurized water reactor. Taking into account the scenario where the thickness of CRUD ranges from 20 microns to 200 microns, the computational analysis of multiple physical fields such as pressurized water reactor neutron physics, flow heat transfer and CRUD can more accurately capture complex physical processes.

The present invention is achieved through the following technical solutions:

The present invention relates to a cross-scale neutronic-thermal-material coupling simulation method for pressurized water reactor CRUD. In the first stage, a neutronics model and a thermal-hydraulic model are used for mutual iterative simulation to obtain the subcooled nucleate boiling position. In the second stage, a multiphysics field coupling simulation is performed using an oxidation corrosion product (CRUD) model, a neutronics model, and a thermal-hydraulic model to obtain a high-resolution simulation under neutronic-thermal-material coupling conditions of the pressurized water reactor.

The multiphysic coupling simulation described herein is described as follows: maintaining the subcooled nucleate boiling condition unchanged, calculating the temperature, density, and thermal conductivity of the CRUD layer using the corrosion oxidation product (CRUD) model, and continuing the iterative process. Specifically, the thermal-hydraulic model performs calculations based on the temperature, density, and thermal conductivity output by the CRUD model, and the neutronics model performs calculations based on the temperature and density results of the thermal-hydraulic model and the CRUD model.

### Technical Effects

This method comprehensively considers the impact of corrosion product deposition on the multiphysic fields of pressurized water reactors (PWRs) and the possible variations in the onset of subcooled nucleate boiling during the iterative process. Based on a high-resolution deterministic simulation approach and an adaptive iteration strategy, it ensures the stability of complex problem solving. Compared with existing technologies, this method significantly improves computational efficiency while maintaining high resolution and reliability. Specifically, when modeling corrosion product deposition (CRUD), this method more accurately characterizes the micron-scale dimensional characteristics of CRUD, avoiding the instability of numerical simulation results caused by the statistical uncertainty in Monte Carlo simulations while also improving computational efficiency. When integrated with a nuclear power plant's digital design platform or safety monitoring system, this simulation methodology can generate significant economic benefits: By enabling high-precision prediction of CRUD-induced power shifts, it reduces the need for physical prototype fabrication and in-core testing of fuel assemblies. Calculations indicate that a single reactor startup-shutdown test costs approximately $2 million USD. Application of this method shortens the design verification cycle by 40% and reduces the R&D cost per fuel assembly by approximately 35%. Real-time monitoring of boron-enriched risk zones allows for early warnings of axial power anomalies up to 30 days in advance. According to EPRI statistics, an unplanned reactor shutdown incurs losses of about $1.2 million USD per day. This method can reduce the occurrence rate of such accidents by over 70%.

### BRIEF DESCRIPTION OF THE DRAWINGS

FIG. 1 is a schematic diagram of a CRUD background mesh;

FIG. 2 is a schematic diagram of the system of the present invention;

FIG. 3 is an iterative cycle flow chart of the method of the present invention;

FIG. 4 (a) shows the arrangement of the fuel assembly, (b) the grid of the guide tube cells, and (c) the schematic diagram of the grid of the fuel rod cells;

FIG. 5 is a schematic diagram showing a comparison of the relative axial power of components before and after the introduction of CRUD in the embodiment;

FIG. 6 is a schematic diagram of relative power distribution of a fuel assembly according to an embodiment;

FIG. 7 is a schematic diagram of boron nucleus density distribution of a fuel assembly according to an embodiment;

FIG. 8 is a schematic diagram of the effect of the embodiment;

FIG. 9 is a schematic diagram of the CRUD model.

### DETAILED DESCRIPTION

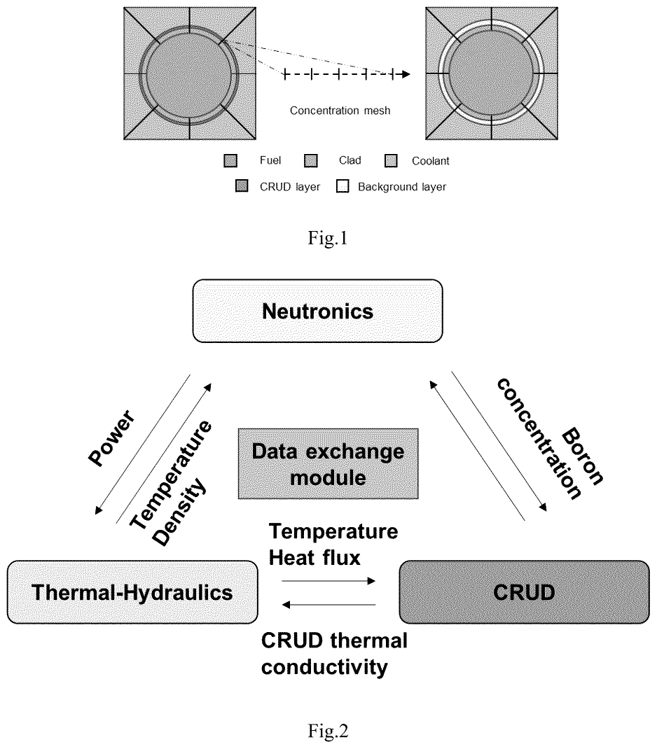

As shown in FIG. 2, a cross-scale neutronic-thermal-material coupling system for CRUD of a pressurized water reactor involved in this embodiment includes a neutron calculation model, a thermal-hydraulic model, a CRUD model, and a data exchange model. The neutron calculation model uses a variational nodal method to solve the neutron transport equation to obtain neutron flux distribution and power distribution. The thermal-hydraulic model uses the coupling of the parallel channel equation and the fuel heat conduction equation to solve the temperature field to obtain the temperature of the material in each region. The CRUD model solves the growth equation and the chemical composition equation to obtain the thickness of the corrosion product and the chemical composition inside it. The data exchange model exchanges and processes data based on the results of each model to achieve multiphysics coupling.

This embodiment is based on the simulation method of the above system, comprising a non-transitory computer readable medium operable on a computer with memory for the simulation method, and comprising program instructions for executing the following steps of:

Step 1: Initialize the coupled system and construct the neutronics model and thermal hydraulic model respectively, including:

1.1 Model the solved PWR fuel grid element and guide tube grid element, and use the mesh division, material layout inside the PWR, and flow conditions as parameters to initialize the physical field.

1.2 The neutron calculation model in the system obtains the multi-group cross-section ox of each nuclide from the ENDF/B-VII.0 cross-section database based on the obtained material information and geometric information, and obtains the effective self-shielding cross-section

$${\sum }_{x g} = \frac{{\int }_{Δ {E}_{g}} n ( E ) {σ}_{x} ( E ) {ϕ}_{F} ( E ) d E}{{\int }_{Δ {E}_{g}} {ϕ}_{F} ( E ) d E} ,$$

of the nuclide g group according to the definition of constant. Among them: φ_{F}(E) is the neutron flux energy spectrum distribution of the gate element, n(E) is the material nuclide density distribution of the gate element, and ox is the microscopic cross-section distribution of the gate element.

1.3 The neutron calculation model obtains the neutron flux φ_{g}(r) at each position and each energy group and the eigenvalue k_{eff} of the core problem by solving the three-dimensional neutron transport equation, and then obtains the volumetric heat generation rate. The coupling system calls the data transmission model to input the data into the thermal hydraulic model.

1.4 The three-dimensional neutron transport equation is:

$$Ω \cdot ∇ ϕ + {\sum }_{t} ( r , E ) ϕ = {\int }_{0}^{∞} {\int }_{4 π} {\sum }_{s} ( r , {E}^{′} ) f ( r , {E}^{′} \to E , {Ω}^{′} \to Ω ) ϕ ( r , {E}^{′} , {Ω}^{′} ) d {E}^{′} d {Ω}^{′} + {Q}_{f} ( r , E , Ω ) + S ( r , E , Ω ) ,$$

Q_{f}(r, E, Ω)+S(r, E, Ω), where: Ω·∇φ is the neutron space leakage. Σₜ(r, E)φ represents neutrons removed from the space due to scattering or absorption reactions. The first term on the right side of the equation represents neutrons generated by scattering within the space. Σₛ represents the macroscopic scattering cross-section. Q_{f}(r, E, Ω) represents neutrons generated by fission reactions. S(r, E, Ω) represents neutrons generated by an independent neutron source.

The volumetric heat generation rate

$${q}^{″} ( r ) = {\sum }_{g = 1}^{G} ( κ {\sum }_{f , g} ( r ) ) {ϕ}_{g} ( r ) where : g = 1 , … , G ,$$

κ is the heat released by a single fission reaction, and Σ_{f,g} is the macroscopic fission cross-section of neutrons.

The volumetric heat generation rate q″(r) obtained by the thermal hydraulic model in the 1.4 system is used to obtain the temperature inside the fuel by solving the fuel heat conduction equation, specifically:

$$\frac{1}{r} \frac{\partial }{\partial r} ( r {κ}_{f} \frac{\partial T}{\partial r} ) + {q}^{″} ( r ) = 0$$

where: κ_{f} is the thermal conductivity of the fuel.

1.5 Based on the obtained fuel heat release, the thermal hydraulic model obtains the fluid temperature and density distribution by solving the fluid mass conservation equations, specifically: energy conservation equation

$$\frac{\partial }{\partial t} ( ρ u h ) + \frac{\partial }{\partial z} ( ρ u h ) = q ( z ) ,$$

momentum conservation equation

$$\frac{\partial }{\partial t} ( ρ u ) + \frac{\partial }{\partial z} ( ρ {u}^{2} ) + \frac{\partial {P}_{fric}}{\partial z} + g ρ + \frac{\partial P}{\partial z} = 0 , and \frac{\partial }{\partial t} ( ρ ) + \frac{\partial }{\partial z} ( ρ u ) = 0 ,$$

where: ρ is the fluid density, u is the fluid velocity, P_{fric} is the friction pressure drop, and P is the flow channel pressure.

The thermal-hydraulic model in the 1.6 system uses the Jens-Lottes correlation

$$Δ {T}_{sat} = {t}_{w} - {t}_{s} = 25 {( \frac{q}{{10}^{6}} )}^{0.25} exp ( \frac{- p}{6.2} )$$

based on the obtained fuel and coolant temperatures. t_{w} is the fuel surface temperature, tₛ is the coolant saturation temperature, q is the heat flux density, and p is the pressure. The system calculates the fuel surface superheat temperature ΔTₛₐₜ in the case of subcooled nucleate boiling and records the position of the fuel surface where subcooled nucleate boiling occurs.

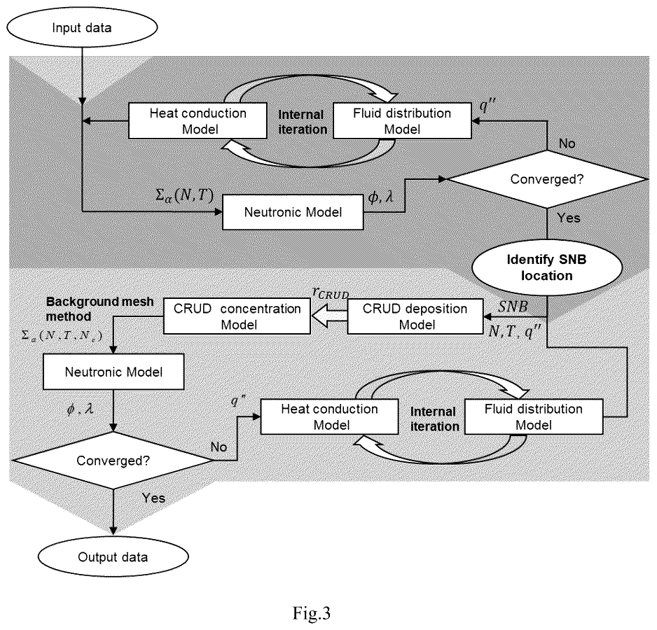

Step 2: The system uses the Picard iteration to perform iteration between the neutronics model and the thermal-hydraulic model according to the coupled iteration strategy shown in FIG. 3. That is, the thermal-hydraulic model calculates based on the power distribution provided by the neutronics model, and the neutronics model updates its database based on the temperature and density results calculated by the thermal-hydraulic model. Specifically, the following steps are performed:

2.1 The system uses the obtained coolant density Dₘ, coolant temperature Tₘ, and fuel temperature T_{f} as key parameters to re-evaluate the cross-sections σₓ≡σₓ(Dₘ, Tₘ, T_{f}) from the cross-section library.

2.2 The system calls the model again to solve the three-dimensional neutron transport equation. If the error between the eigenvalue k_{eff} of the problem and the last calculated value is less than 50 PCM, the eigenvalue is considered to have converged. Otherwise, the thermal-hydraulic model is calculated and the parameters are updated.

Step 3: When the eigenvalues calculated by the neutronics model converge, record the subcooled nucleate boiling condition under the current physical field and execute step 4; otherwise, repeat step 2.

Step 4: The system maintains the subcooled nucleate boiling condition and changes the coupled iteration strategy. The temperature, density, and thermal conductivity of the CRUD layer are calculated using the corrosion oxidation product (CRUD) model. The iterative process continues. The coupled iteration strategy is shown in the lower half of FIG. 3. That is, the thermal-hydraulic model calculates the temperature, density, and thermal conductivity output by the CRUD model. The neutronics model updates its database based on the temperature and density results of the thermal-hydraulic model and the CRUD model for calculation. Specifically, it includes:

4.1 Based on the coolant boron concentration under the current operating conditions and the heat flux density, fuel surface temperature, and coolant temperature calculated from the thermal model, the particle deposition equation mₚ=h_{mt,p}Σᵢc_{p,i}, the solute crystallization deposition equation

$${m}_{s} = \frac{{h}_{cr , s} {h}_{mt , s}}{{h}_{cr , s} + {h}_{mt , s}} {\sum }_{i} ( {c}_{c l adding , i} - {c}_{sat , i} ) ,$$

and the deposition erosion equation

$${m}_{r} = {k}_{e r} \frac{τ}{{W}_{a} - {E}_{t o t}}$$

d are solved to obtain the final deposition result \dot{m}=mₛ+mₚ−mᵣ where: hₘₜ is the mass transfer coefficient, c_{p,i} is the particle concentration, her is the crystallization coefficient, c_{cladding,i} is the surface concentration, c_{sat,i} is the saturation concentration, kₑᵣ is the erosion constant, τ is the shear force, Wₐ is the work done on the eroded surface, and Eₜₒₜ is the adhesion energy.

4.2 Using the results obtained from the deposition model, the chemical composition inside the CRUD is calculated using a one-dimensional background mesh, and the chemical equilibrium equation

$$\frac{\partial {c}_{i}}{\partial t} = [ ( \vec{u} \cdot \vec{n} ) - ∇ {D}_{i} ] ∇ {c}_{i} + {\sum }_{i} ( {c}_{i} - {c}_{i , s i n k} )$$

is solved, where: Dᵢ is the fractal coefficient, and the boron concentration c_{boron}(r) at each location is obtained.

4,3 Based on the results of the CRUD chemical composition model, the system establishes a cross-scale model and uses a one-dimensional background mesh for the radial distribution of boron concentration in the CRUD layer, as shown in FIG. 1.

$${N}_{b} = \frac{{\int }_{0}^{R} N ( r ) r d r}{R} ,$$

N(r) is set to be the regional nuclide density to obtain the boron concentration N_{b} of the CRUD background layer, which is passed to the neutron model for calculation.

4.4 Based on the thickness of the deposited layer calculated from the CRUD deposition model, solve for the CRUD thermal conductivity,

$$∇ \cdot ( {κ}_{CRUD} ∇ T ) = {q}_{s i n k}^{′′′} where : {q}_{s i n k}^{′′′} ∝ {r}_{c} {N}_{c} {h}_{c} ∈ ( ε ) ( T - {T}_{sat} ) ,$$

where: r_{c} is the characteristic chimney radius, N_{c} is the chimney density, h_{c} is the boiling heat transfer coefficient, and ∈(ε) is the permeability, which is a function of the porosity ε. The CRUD thermal conductivity κ_{CRUD} is solved and used to calculate the updated thermal model.

Step 5: When the eigenvalues calculated by the neutron model converge, the coupled system completes the simulation and obtains the three-dimensional nuclear thermal material coupled temperature field, neutron flux field and power distribution of the problem. Otherwise, repeat step 4.

As shown in FIG. 9, the CRUD model involved in this embodiment includes a CRUD deposition model, a CRUD chemical composition model, and a CRUD thermal conductivity model. The CRUD deposition model uses the coolant boron concentration under current operating conditions, the heat flux calculated by the thermal model, and other parameters such as temperature to calculate the deposition layer thickness and fluid surface heat transfer coefficient of the CRUD under a certain operating time. The CRUD chemical composition model uses the coolant boron concentration under current operating conditions, the heat flux calculated by the thermal model, the fuel surface temperature, the coolant temperature, and the deposition layer thickness calculated by the CRUD deposition model to solve the chemical equilibrium equation using a one-dimensional background mesh to obtain the boron concentration at each location of the corrosion product. The CRUD thermal conductivity model uses the deposition layer thickness calculated by the CRUD deposition model to obtain the thermal conductivity of the CRUD deposition.

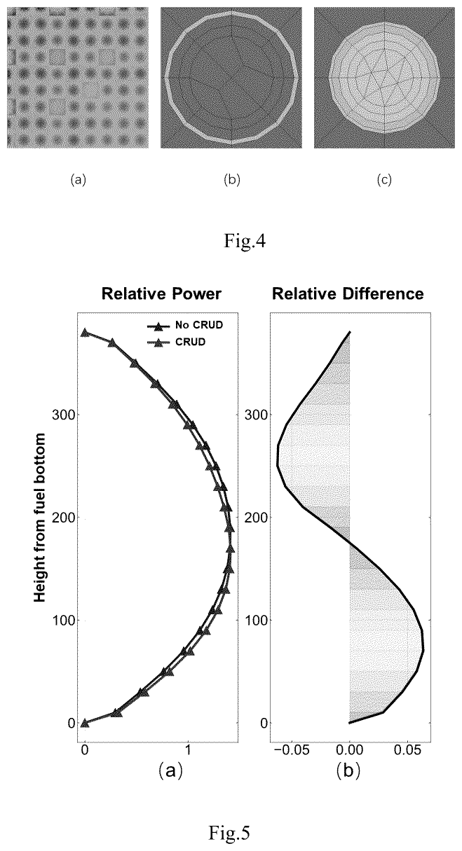

In practical experiments, the coupled system, running on a 2×7285H32C HPC cluster, utilized 9 nodes with 576 cores to perform three-dimensional modeling and calculations using a quarter-model of a typical pressurized water reactor fuel assembly. The fuel assembly consisted of 17×17 grid cells, comprising 264 fuel rod cells and 25 guide tube cells. In terms of axial arrangement, the active length of the fuel was 380 cm, with a 20 cm water reflector layer at each end. Beyond the reflector layer, a vacuum boundary condition was applied. In the radial direction, the grid cells were arranged as shown in FIG. 4. The grid cell pitch was 1.26 cm, forming a 21.5 cm wide fuel assembly. Reflective boundary conditions were applied at the assembly boundaries.

For the thermal-hydraulic calculation model, the coolant inlet temperature of the component model is 565K, the inlet mass flow rate is set to 24.056 kg/s, and the operating pressure is 15.5 MPa. For each grid cell, 10 radial mesh points are divided to calculate the detailed heat transfer condition. In addition, the model also considers the heat conduction of the fuel grid cell in the air gap region.

In the calculation of the CRUD model, the operating conditions of the pressurized water reactor fuel assembly after 180 days of steady-state operation were simulated, and the boron concentration in the coolant under the operating conditions was 1300 ppm.

For the above model, during the iterative process of the nuclear-thermal CRUD coupled calculation, convergence was achieved after three iterations to determine the subcooled nucleate boiling location. The k_{eff} of the fuel assembly decreased from 1.17685 to 1.16184, reflecting the influence of reactor assembly temperature effects. Subsequently, the CRUD model was introduced for coupled iterations, and convergence was achieved after two iterations. The k_{eff} of the fuel assembly decreased from 1.16184 to 1.15891, a decrease of 293 pcm. This indicates that the presence of CRUD enhances neutron absorption within the reactor assembly. Accurately analyzing the impact of CRUD on the overall assembly is crucial for reactor design, operation, and evaluation.

The calculated impact of CRUD on the axial power distribution of the fuel assembly is shown in FIG. 5. After accounting for CRUD, the axial power distribution shifts downward by approximately 50 cm toward the core base. Specifically, FIG. 5 shows a significant power reduction at axial height of 250-300 cm, with the assembly power peak shifts from 170 cm to 130 cm. This shift is attributed to the boron enrichment. This shift in power distribution results in an approximately 22% increase in peak power, with the power peaking factor rising from 1.409 to 1.719. This increase poses a significant risk to the safe operation of the reactor.

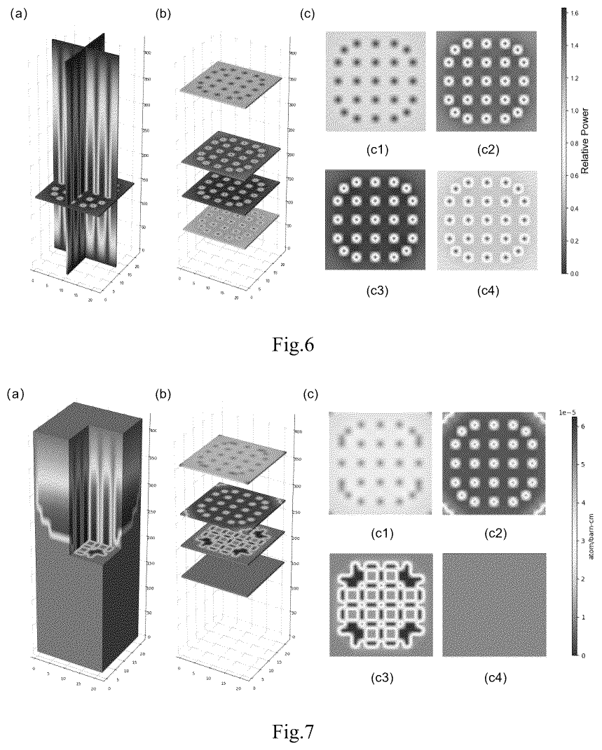

As shown in FIG. 6, the three-dimensional power distribution characteristics and local radial power distribution characteristics of the assembly are shown. It can be observed from the color legend that at certain local locations of the assembly, the power peak exceeds 1.63 times the axial average power peak. As shown in FIG. 4(a), the presence of the guide tube introduces discontinuity in the radial power distribution, which has a significant impact on the overall radial power distribution. Combined with FIG. 4(b), it can be found that the power distribution of the fuel assembly shows a trend of being higher at the center and decreasing toward the periphery, with the power peak concentrated in the area close to the guide tube. For example, the relative power peaking factor in the center of the assembly reaches 1.64, while the relative power peaking factor in the peripheral area drops to 1.43, a 14% difference.

FIG. 7 shows the distribution of boron nuclide density within the model, reflecting the accumulation of boron due to CRUD. As shown in FIG. 7(a), CRUD deposition is primarily concentrated between 210 cm and 380 cm in model height. With increasing height, the thickness of the CRUD and the corresponding boron concentration decrease with height. FIG. 7(b) shows the radial boron nuclide density variation at model heights of 150 cm, 210 cm, 270 cm, and 360 cm, and FIG. 7(c) shows the distribution at these heights. As shown in FIG. 7(c4), in the lower region of the model, the boron nuclide density is uniformly distributed at 9.525×10−6 atom/barn-cm, which is the same as the inlet coolant boron concentration, indicating no potential risk of CRUD deposition. Comparing FIG. 7(c3) with FIG. 7(c2), it is observed that subcooled nucleate boiling is not uniform in the radial direction within the model. From an axial perspective, subcooled nucleate boiling first appears at an altitude of 210 cm. In the radial direction, CRUD development initials in a relatively high-power region near the center of the assembly, close to the guide tube, and then gradually spreads across most of the assembly. As shown in FIGS. 7(c1) and 7(c2), the accumulation of CRUD and the overall thickness of the initial region of subcooled nucleate boiling decrease with increasing altitude. At an altitude of 360 cm, the average boron nuclide density was measured to be 2.185×10-5 atom/barn-cm, which is equivalent to 40% of the boron nuclide density at 270 cm (5.094×10-5 atom/barn-cm).

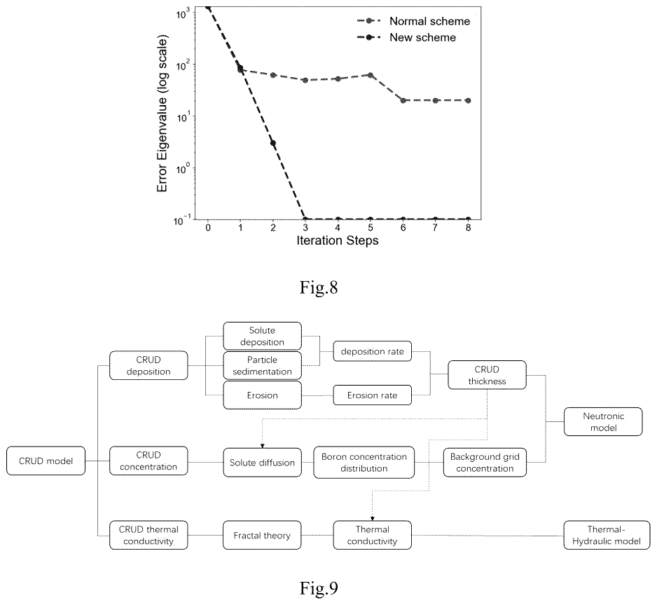

As shown in FIG. 8, compared to existing technologies, this method uses the probabilistic Monte Carlo method as a reference solution. The background mesh method enables cross-scale computation at the cell level while introducing only a 31 PCM error. This compares to the case where no background mesh method is used, which results in an increased numerical error of 969 PCM. For the Picard iterations of the three physical fields, this method avoids the oscillation problem caused by the uncertainty of the subcooled nucleate boiling position and reduces the average number of iterative convergence steps from 8 to 3, an improvement of approximately 60%.

The above-mentioned specific implementation can be partially adjusted in different ways by those skilled in the art without departing from the principles and purpose of the present invention. The scope of protection of the present invention shall be based on the claims and shall not be limited by the above-mentioned specific implementation. All implementation schemes within its scope shall be subject to the constraints of the present invention.

What is claimed is:

1. A cross-scale neutronic-thermal-material coupled simulation method for CRUD in a pressurized water reactor (PWR), characterized by: in the first stage, cyclic iterative simulations are performed using a neutronics model and a thermal-hydraulic model to obtain the subcooled nucleate boiling condition; in the second stage, multiphysics coupled simulations are performed using the CRUD model, the neutronics model, and the thermal-hydraulic model to obtain a high-resolution simulation under PWR neutronic-thermal-material coupled conditions;
and the multiphysics coupling simulation refers to: maintaining the subcooled nucleate boiling condition unchanged, calculating the temperature, density, and thermal conductivity of the CRUD region using the CRUD model, and continuing the iterative process, that is, the thermal-hydraulic model calculates based on the temperature, density, and thermal conductivity output by the CRUD model, and the neutronics model updates its database and performs calculations based on the temperature and density results of the thermal-hydraulic model and the CRUD model;
and the CRUD model includes: a CRUD deposition model, a CRUD chemical component model and a CRUD thermal conductivity model.

2. The cross-scale neutronic-thermal-material coupled simulation method for pressurized water reactor CRUD according to claim 1 is characterized by specifically comprising:
Step 1: Initialize the coupled system and construct the neutronics model and thermal hydraulic model respectively;
Step 2: Use the Picard iteration to perform iteration between the neutronics model and the thermal-hydraulic model, and that is, the thermal-hydraulic model calculates based on the power distribution provided by the neutronics model, and the neutronics model updates its database for calculation based on the temperature and density results calculated by the thermal-hydraulic model;
Step 3: When the eigenvalues (i.e., effective multiplication factor k_{eff}) calculated by the neutronics model converge, record the subcooled nucleate boiling condition under the current physical field and execute step 4; otherwise, repeat step 2;
Step 4: Maintaining the subcooled nucleate boiling condition, the temperature, density, and thermal conductivity of the CRUD region are calculated using the CRUD model, and the iterative process continues, and the thermal-hydraulic model performs calculations based on the temperature, density, and thermal conductivity output by the CRUD model, and the neutronics model performs calculations based on the temperature and density results from the thermal-hydraulic model and the CRUD model;
Step 5: When the eigenvalues calculated by the neutron model converge, complete the simulation to obtain the three-dimensional nuclear-thermal material coupled temperature field, neutron flux field and power distribution of the problem. Otherwise, repeat step 4.

3. The cross-scale neutronic-thermal-material coupled simulation method for pressurized water reactor CRUD according to claim 2, wherein said step 1 specifically comprises:
1.1 Model the solved PWR fuel grid element and guide tube grid element, and use the meshing, material layout, and flow conditions inside the PWR as parameters to initialize the physical field;
1, 2 The neutron calculation model in the system obtains the multi-group cross-section σₓ of each nuclide from the ENDF/B-VII.0 cross-section database based on the obtained material information and geometric information, and calculates the effective self-shielding cross-section of the nuclide group g,
$${\sum }_{x g} = \frac{{\int }_{Δ {E}_{g}} n ( E ) {σ}_{x} ( E ) {ϕ}_{F} ( E ) d E}{{\int }_{Δ {E}_{g}} {ϕ}_{F} ( E ) d E} where : {ϕ}_{F} ( E )$$
is the neutron flux energy spectrum distribution of the grid element, n(E) is the material nuclide density distribution of the grid element, and σₓ is the microscopic cross-section distribution of the grid element;
1.3 The neutron calculation model obtains the neutron flux φ_{g}(r) at each position and energy group and the eigenvalue k_{eff} of the core problem by solving the three-dimensional neutron transport equation, and after obtaining the volumetric heat generation rate, the coupling system calls the data transmission model to input the data into the thermal hydraulic model;
and the volumetric heat generation rate q″(r) obtained by the thermal hydraulic model in the 1.4 system is used to obtain the temperature inside the fuel by solving the fuel heat conduction equation, specifically:
$$\frac{1}{r} \frac{\partial }{\partial r} ( r {κ}_{f} \frac{\partial T}{\partial r} ) + {q}^{″} ( r ) = 0$$
where: κ_{f} is the thermal conductivity of the fuel;
1.5 Based on the obtained fuel heat release, the thermal hydraulic model obtains the fluid temperature and density distribution by solving the fluid mass conservation equations, specifically: energy conservation equation
$$\frac{\partial }{\partial t} ( ρ u h ) + \frac{\partial }{\partial z} ( ρ u h ) = q ( z ) ,$$
momentum conservation equation
$$\frac{\partial }{\partial t} ( ρ u ) + \frac{\partial }{\partial z} ( ρ {u}^{2} ) + \frac{\partial {P}_{fric}}{\partial z} + g ρ + \frac{\partial P}{\partial z} = 0 , and \frac{\partial }{\partial t} ( ρ ) + \frac{\partial }{\partial z} ( ρ u ) = 0 ,$$
where: ρ is the fluid density, u is the fluid velocity, P_{fric} is the friction pressure drop, and P is the flow channel pressure;
and the thermal-hydraulic model in the 1.6 system uses the Jens-Lottes correlation
$$Δ {T}_{sat} = {t}_{w} - {t}_{s} = 25 {( \frac{q}{{10}^{6}} )}^{0.25} exp ( \frac{- p}{6.2} )$$
based on the calculated fuel and coolant temperatures, the said t_{w} is the fuel surface temperature, tₛ is the coolant saturation temperature, q is the heat flux density, and p is the pressure, and the system calculates the fuel surface superheat temperature ΔTₛₐₜ in the case of subcooled nucleate boiling, and the system records the fuel surface location where subcooled nucleate boiling occurs.

4. The cross-scale neutronic-thermal-material coupled simulation method for pressurized water reactor CRUD according to claim 2, wherein said step 2 specifically comprises:
2.1 Based on the obtained coolant density Dₘ, coolant temperature Tm, and fuel temperature Tf as key parameters, multi-group cross-sections σₓ≡σₓ(Dₘ,Tₘ,T_{f}) are extracted from the cross-section library again;
2.2 To solve the three-dimensional neutron transport equation, and if the error between the eigenvalue k_{eff} of the problem and the last calculated value is less than 50 PCM, the eigenvalue is considered to have converged, otherwise, the thermal-hydraulic model is used to calculate and update the parameters.

5. The cross-scale neutronic-thermal-material coupled simulation method for PWR CRUD according to claim 3, wherein the three-dimensional neutron transport equation is
$$Ω \cdot ∇ ϕ + {\sum }_{t} ( r , E ) ϕ = {\int }_{0}^{∞} {\int }_{4 π} {\sum }_{s} ( r , {E}^{′} ) f ( r , {E}^{′} \to E , {Ω}^{′} \to Ω ) ϕ ( r , {E}^{′} , {Ω}^{′} ) {dE}^{′} d {Ω}^{′} + {Q}_{f} ( r , E , Ω ) + S ( r , E , Ω ) ,$$
wherein: Ω·∇φ is the leakage of neutron space; Σ^{t}(r, E)φ is the neutrons removed from the space due to scattering or absorption reactions; the first term on the right side of the equation is the neutrons generated by scattering phenomena in the space; Σₛ is the macroscopic scattering cross-section; Q_{f}(r, E, Ω) is the neutrons generated by fission reactions; and S(r, E, Ω) is the neutrons generated by an independent neutron source;
and the volumetric heat generation rate is
$${q}^{″} ( r ) = {\sum }_{g = 1}^{G} ( κ {\sum }_{f , g} ( r ) ) {ϕ}_{g} ( r ) , where : g = 1 , … , G , κ$$
is the heat released by a single fission reaction, and Σ_{f,g} is the macroscopic fission cross-section of the neutron.

6. The cross-scale neutronic-thermal-material coupled simulation method for pressurized water reactor CRUD according to claim 1, wherein said step 4 specifically comprises:
4.1 Based on the coolant boron concentration under the current operating conditions and the heat flux density calculated by the thermal model, the fuel surface temperature, and the coolant temperature, the particle deposition equation mₚ=h_{mt,p}Σᵢc_{p,i}, the solute crystallization deposition equation is
$${m}_{s} = \frac{{h}_{cr , s} {h}_{mt , s}}{{h}_{cr , s} + {h}_{mt , s}} {\sum }_{i} ( {c}_{c l adding , i} - {c}_{sat , i} ) ,$$
and the deposition wear equation is
$${m}_{r} = {k}_{e r} \frac{τ}{{W}_{a} - {E}_{t o t}} d ,$$
are solved to obtain the final deposition result \dot{m}=mₛ+mₚ−mᵣ, where: hₘₜ is the mass transfer coefficient, c_{p,i} is the particle concentration, h_{cr} is the crystallization coefficient, c_{cladding,i} is the surface concentration, c_{sat,i} is the saturation concentration, kₑᵣ is the erosion constant, t is the shear force, Wₐ is the work done on the eroded surface, and Eₜₒₜ is the adhesion energy;
4.2 Using the results obtained from the deposition model, the chemical composition inside the CRUD is calculated using a one-dimensional background mesh, and the chemical equilibrium equation
$$\frac{\partial {c}_{i}}{\partial t} = [ ( \vec{u} \cdot \vec{n} ) - ∇ {D}_{i} ] ∇ {c}_{i} + {\sum }_{i} ( {c}_{i} - {c}_{i , sink} ) ,$$
is solved, where: Dᵢ is the fractal coefficient, and the boron concentration c boron (r) at each location is obtained;
4.3 The results of the CRUD chemical composition model are used to establish a cross-scale model, set
$${N}_{b} = \frac{{\int }_{0}^{R} N ( r ) r d r}{R} ,$$
N(r) as the regional nuclide density, and obtain the boron concentration N_{b} in the CRUD background layer, which is then passed to the neutron model for calculation;
4.4 Based on the thickness of the sediment layer calculated by the CRUD deposition model, the thermal conductivity of CRUD is solved,
$$∇ \cdot ( {κ}_{CRUD} ∇ T ) = {q}_{s i n k}^{′′′} , where : {q}_{s i n k}^{′′′} ∝ {r}_{c} {N}_{c} {h}_{c} ∈ ( ε ) ( T - {T}_{sat} ) ,$$
where: r_{c} is the chimney characteristic radius, N_{c} is the chimney density, h_{c} is the boiling heat transfer coefficient, ∈(ε) is the permeability, which is a function of the porosity ε, and the CRUD thermal conductivity κ_{CRUD} is solved and used to calculate the updated thermal model.

7. The cross-scale neutronic-thermal-material coupled simulation method for pressurized water reactor CRUD according to claim 1, characterized in that the CRUD deposition model uses the coolant boron concentration under current operating conditions and the heat flux and temperature calculated by the thermal model to obtain the CRUD deposition layer thickness and fluid surface heat transfer coefficient;
and the CRUD chemical composition model uses the coolant boron concentration under current operating conditions, the heat flux density, fuel surface temperature, coolant temperature calculated by the thermal model, and the deposition layer thickness calculated by the CRUD deposition model to solve the chemical equilibrium equation through a one-dimensional background mesh to obtain the boron concentration at each location of the CRUD;
and the CRUD thermal conductivity model obtains the thermal conductivity of the CRUD deposition based on the thickness of the deposition layer calculated by the CRUD deposition model.

8. A cross-scale neutronic-thermal-material coupling system for CRUD of a pressurized water reactor for implementing the method described in claim 1, characterized in that it includes: a neutron calculation model, a thermal-hydraulic model, a CRUD model and a data exchange model, wherein: the neutron calculation model uses a variational nodal method to solve the neutron transport equation to obtain the neutron flux distribution and power distribution, the thermal-hydraulic model uses the coupling of the parallel channel equation and the fuel heat conduction equation to solve the temperature field to obtain the temperature of the material in each area, the CRUD model solves the growth equation and the chemical composition equation to obtain the thickness of the CRUD and the chemical composition inside it, and the data exchange model exchanges and processes data according to the results of each model to achieve multiphysics coupling.
